(19) United States
(12) Patent Application Publication
(10) Pub. No.: US 2006/0110614 A1
(43) Pub. Date: May 25, 2006

(54) Method for manufacturing multimaterial parts and multimaterial part

(76) Inventor: Jari Liimatainen, Tampere (FI)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/531,871

(22) PCT Filed: Oct. 31, 2003
(86) PCT No.: PCT/FI03/00808

§ 371 Date: May 20, 2005

(30) Foreign Application Priority Data
Nov. 1, 2002 (FI) 20021950

(51) Int. Cl. B32B 15/04; B32B 9/00

(52) U.S. Cl. 428/469; 428/698; 428/472; 419/14; 419/49

(57) ABSTRACT

The invention relates to method for manufacturing multimaterial parts, the multimaterial used in the method containing a tough material component (B) and a hard, wear-resistant material (A), in which method a green body is prepared from the tough material component (B) and the hard material component (A) by isostatic hot pressing into a substantially densified green body, whereupon the green body is hot worked up to hot working degree 2 minimum so as to obtain a desired distribution between the tough material component (B) and the hard material component (A). The invention also relates to a multimaterial part manufactured using the method.

The present invention relates to a method for manufacturing a multimaterial part comprising materials of different properties. More specifically, the invention relates to manufacture of a multimaterial part by hot isostatic pressing and hot working.

### BACKGROUND OF THE INVENTION

In the development of wear-resistant materials, it has generally been difficult to combine wear resistance with sufficient mechanical durability, particularly with toughness. Better wear resistance has generally been sought by way of increasing material hardness through alloying, heat treatment and working. In many cases the wear resistance is improved by embedding ceramic carbide, nitride and carbonitride particles and other extreme hard, wear-resistance-improving particulate components in the base material matrix. However, these techniques of hardness improvement and use of embedded hard particles in the base material matrix degrade the material toughness and increase the risk of cracks and chipping at peak loads imposed on the material.

If the wear resistance-toughness combination obtainable in a monolithic homo-geneous material is not satisfactory, an alternative approach generally used is to manufacture different kinds of coatings and composite structures in which only the eroding portion of a wearing part is comprised of a material that locally has a high wear resistance but generally at the same time is also quite brittle. Then, a local fracture in the wear-resistant material does not necessarily mean that the entire wearing part must be discarded or that a hazardous situation will be imposed on equipment, a process or operating personnel. Anyhow, material fractures obviously cause substantial increase in the wear rate as compared with normal abrasive and erosive wear. Typical manufacturing methods of composite structures are weld-on, brazing, casting and mechanical joining including shrink joints, for instance.

Under certain conditions, however, it is necessary to constrain the chipping rate of material off from a part under extremely severe operating loads and impacts. Such applications cover, among others, hammer mills, grinder mills, shredders and impact crushers in which the impact load frequency is so high that if the wear mechanism is allowed to reach a chipping state, the erosion rate of the wear resistant material takes place excessively fast.

Still other methods known in the art for constraining erosion rate under the circumstances described above include surfacing the wearing part with small wear-resistant inserts that are brazed or glued on the wearing area of the base material. This method, however, is expensive and involves work-intensive preparations. Also mechanical joining of materials is plagued by the same problems, namely, costly preparation and fitting of material components being joined increase substantially the manufacturing costs of components.

### DESCRIPTION OF THE INVENTION

In the method according to the invention, the material is produced from a first material component (A) of microscopically high resistance to wear and a second material component (B) of a tough and mechanically durable composition such that under extremely ardent load situations constrains the size of metallic chips detaching from the component surface and thus prevents macroscopic fractures of catastrophic scale. The toughness-improving material component (B) is embedded in the wear-resistant component so that a maximal benefit is gained in regard to the expected operating loads while on the other hand the adverse effect on the wear resistance is minimized.

The tough, mechanically durable material component (B) may be embedded in the composite structure as fibers, platelets or such a honeycomb shape that encloses the regions of the hard component (A). At the chipping of the hard material component (A), the separation of the chips is prevented by the reinforcing network of the fibrous component (B) thus binding the chips to the overall composite structure for maximally long time. Honeycomb-like reinforcing structures function in the same fashion and, besides, are superior to fiber reinforcing in constraining the maximum size of a detached chip. As to the use of platelets in the composite structure, it is necessary to know exactly the orientation of operating load forces in order to avoid longitudinal fracture of the hard material component in its longitudinal direction as it is embedded in the tough component or along the interface planes of the two components.

The wearing part material manufactured according to the invention offers a superior combination of wear resistance and toughness than what can be achieved by using a homogeneous material of equal wear resistance alone. Furthermore, proper selection of material components (A) and (B) and the size distribution of their regions in the composite structure, a desired combination of wear resistance and toughness may be obtained for different applications, whereby the chipping and erosion of a wearing part can be controlled.

More specifically, the method according to the invention is characterized by what is stated in the characterizing part of claim 1 and the part according to the invention is characterized by what is stated in the characterizing part 6.

The manufacturing method according to the invention comprises the following steps:
I. Sheet metal is worked into a mold capsule that is charged with toughness-improving solid material component (B) and metallurgical powder (A) of a wear-resistant material component. The metallurgical powder (A) may be a single grade of prealloyed metal powder or a mixture of different metal and/or ceramic powders.
II. The charge is densified with the help of elevated pressure and temperature into a green body so dense that it can be hot-worked thus rendering the composite material a desired end density and volume reduction with a desired distribution between the regions of materials (A) and (B).
III. The hot-worked body is subjected to necessary postprocessing steps such as machining and heat treatments as dictated by the properties of material components (A) and (B).
IV. The postprocessed wear-resistant finished material is joined by brazing, mechanical techniques, glueing or welding to a desired point of the part being manufactured.

The particle size and quantity of component (B) to be loaded into the mold in phase I are selected such that the size distribution of different regions after the working of the composite material is suitable for the intended application. In the selection of the material components it is also important to verify for both material types the compatibility of the process parameters (densification, hot-working, heat treatment) to be employed during the processing of the material components (A) and (B). Further, formation of excessively brittle microstructures on the interface between material components (A) and (B) must be prevented to avoid a cracking fracture of component (B) apart from component (A) during operating load peaks because such fractures deteriorate the toughness of the composite material. This is particularly disadvantageous if the composite material is made using platelet-type reinforcing materials (B) and the orientation of loading stresses is such that the fracture may proceed along an interface between the regions of material components (A) and (B). Moreover, the temperature coefficients of expansion of materials (A) and (B) may not differ excessively from each other, because otherwise between the material particulates (A) and (B) of the composite material will develop high residual stresses that increase the cracking sensitivity of the composite material or promote formation of fatigue fractures.

The toughness-improving component (B) may be loaded into the mold in the form of fibers/wires, platelets/plates or as a honeycomb structure, depending on the microscale structure that is desired from the composite material after it is hot-worked. Depending on the component geometry and desired distribution of the tough material particulates (B), in certain cases it may advantageous to fill-in also the tough component (B) in powderized or predensified form. Adding the tough component in powderized form may further be the most advantageous choice in the manufacture of parts in which the tough material particulates are desired to create platelet-like toughening structures in the manufactured material. Predensification is advantageous when the discrepancies appearing from different characteristics of the of the entirely dense, tough component (B) that does not change its dimensions during densification and the powderized-form hard component (A) embedding the particulates of the former component. Herein, the use of a predensified material component (B) allows easy fill-in of the material into the mold and, on the other hand, due to the inherent porosity of the material undergoes some contraction during densification thus aiding the control of deformations in the entire densified body.

The powderized material (A) can be either prealloyed powder or a mixture of plural different metallic and/or ceramic powders that gives the desired properties in the intended application. Equally in regard to the tough material (B), the hard material (A) can be filled into the mold either in predensified form or as fully densified material if such an arrangement is most advantageous due to the geometry of the part being manufactured or desired distribution of the material particulates therein.

The tough component (B) used in the method according to the invention is a ferrous material, that is, its iron content is greater than 50 wt. %.

To make the green body hot-workable, the material packed into the mold can be densified by sintering, for instance, or, preferably, using the well-known hot isostatic pressing technique. Hot isostatic pressing offers complete densification and best results in hot working, whereby also the liberty of hot-working method is widest. Sintering does not give as good a degree of densification thus requiring the hot working of the body to be carried out using methods, such as as hot powder injection molding, that offer inferior hot workability. In contrast, a body produced using hot isostatic pressing can be subjected to such working as hot rolling, radial forging or open forging. The volume reduction occurring during hot working can be utilized to influence the distribution between the material components (A) and (B).

After hot working of the composite material, the bodies are separated for mounting them on the wearing part and are subjected necessary postprocessing prior to the final bonding to the part being manufactured. In certain cases the prepared composite material pieces can be bonded by welding or hot isostatic pressing to the part being manufactured, whereupon the entire part can be subjected to heat treatment.

In the method according to the invention, the pressed green bodies are hot worked up to a hot working degree 2 minimum. The working degree is determined from the cross-sectional areas of the body prior to and after hotworking.

Alternatively, the material can be fabricated in a single pressing step if so found advantageous as to the manufacturing costs and quality of the wearing part. Using hot isostatic pressing, for instance, a desired network structure can be first constructed from the tough material component (B) into the mold capsule and thereupon the voids of the mold capsule are filled with the hard material component (A) thus directly achieving the desired distribution between the material components (A) and (B) after the hot pressing step. This alternative is most advantageous in situations where the distribution between the hard component (A) and the tough component (B) is relatively coarse, that is, e.g., if the interfiber spacing is greater than 15 mm when using fiber-like tough material particulates.

In the method according to the invention, the wear-resistant component (A) and the tough component (B) may be in powderized, partially densified or entirely solid state prior to starting the densification of the green body.

In an embodiment of the method according to the invention, the wear-resistant component (A) is advantageously a ferrous material having an iron content greater than 50 wt. % or, alternatively, a mixture of a ferrous material and a ceramic material (carbide, oxide, nitride, boride, etc.) containing not more than 30 wt. % of a metallic binder, whereby the hardness of the material is greater than HRC 35, advantageously greater than HRC 50.

In an embodiment of the method according to the invention, the tough component (B) is advantageously a ferrous or nickel-based material with a nickel content greater than 50 wt. %, whereby the hardness of the material is not greater than HRC 35, advantageously not greater than HRC 25.

One grade of the wear-resistant material component (A) employed in the invention is advantageously prepared from a powderized raw material in which the chemical composition of the ferrous metallic powder in the powderized mixture is 0.5-3.5 wt. % carbon, 0.5-15 wt. % chromium, 0-5 wt. % molybdenum, less than 2 wt. % manganese and less than 2 wt. % silicon, and the proportion of the carbide-forming additives such as V, Nb, Ti and W compounds in total is 3-20 wt. %. Additionally, the powderized mixture contains not more than 50 wt. % ceramic particulates in which the proportion of a binder is not greater than 30 wt. %. The rest of the powder mixture composition comprises impurities or trace amounts of different additives.

The method according to the invention provides a workable green body for the manufacture of a multimaterial part wherein a tough material component (B) forms along the longitudinal direction of the green body an essentially homogeneous structure whose proportion in the green body cross section is 10-50 vol. %. In the finished multimaterial part, the cross-sectional area of a single fiber of the tough material is advantageously greater than 1 mm² average and the minimum dimension in the cross section of a single fiber or in the wall a honeycomb-like tough structure is advantageously greater than 0.5 mm, and the hardness of the hard material component after heat treatment is advantageously not less than HRC 40. Furthermore, the volume proportion of the tough material component (B) in the finished multimaterial part is advantageously 20-40 vol. %.

1. A method for manufacturing multimaterial parts, the multimaterial used in the method containing a tough ferrous (Fe>50 wt. %) material component (B) in a desired distribution with a hard, wear-resistant material (A), in which method a green body is prepared from the tough material component (B) and the hard material component (A) by isostatic hot pressing into a substantially densified green body, wherein the green body is hot worked up to a hot working degree 2 minimum so as to obtain a desired distribution between the tough material component (B) and the hard material component (A), and the working degree is determined from the cross-sectional areas of the body prior to and after hotworking.

2. The method of claim 1, wherein the wear-resistant component (A) and the tough component (B) may be in either powderized, partially densified or entirely solid state prior to starting the densification of the green body.

3. The method of claim 1, wherein the wear-resistant component (A) is a ferrous material (Fe>50 wt. %) or, alternatively, a mixture of a ferrous material and a ceramic material (carbide, oxide, nitride, boride, etc.) containing not more than 30 wt. % of a metallic binder, whereby the hardness of the material is greater than HRC 35.

4. The method of claim 1, wherein the tough material component (B) is a ferrous (Fe>50 wt. %) or nickel (Ni>50 wt. %) based material, whereby the hardness of the material is not greater than HRC 35.

5. The method of claim 1, wherein the wear-resistant material component (A) is prepared from a powderized raw material in which the chemical composition of the ferrous metallic powder (Fe>50 wt. %) in the powderized mixture is 0.5-3.5 wt. % carbon, 0.5-15 wt. % chromium, 0-5 wt. % molybdenum, less than 2 wt. % manganese and less than 2 wt. % silicon, and the proportion of the carbide-forming additives such as V, Nb, Ti and W compounds in total is 3-20 wt. % and, additionally, the powderized mixture contains not more than 50 wt. % ceramic particulates in which the proportion of a metallic binder is not greater than 30 wt. %, the rest of the composition comprising impurities or trace amounts of different additives.

6. A multimaterial part manufactured according to claim 1 whose composition includes at least a tough ferrous (Fe>50 wt. %) material component (B) combined with a hard, wear-resistant material (A), wherein:
the tough material component (B) forms in a workable green body an essentially homogeneous longitudinal structure, whose proportion in the green body cross section is 10-50 vol. %,
the cross-sectional area of a single fiber of the tough material (B) is greater than 1 mm² average and the minimum dimension in the cross section of a single fiber or in the wall a honeycomb-like tough structure is greater than 0.5 mm, and
the hardness of the hard material component (A) after heat treatment is not less than HRC 40.

7. The multimaterial part of claim 6, wherein the volume proportion of the tough material component (B) in the finished multimaterial part is 20-40 vol. %.

8. The method of claim 2, wherein the wear-resistant component (A) is a ferrous material (Fe>50 wt. %) or, alternatively, a mixture of a ferrous material and a ceramic material (carbide, oxide, nitride, boride, etc.) containing not more than 30 wt. % of a metallic binder, whereby the hardness of the material is greater than HRC 35.

9. The method of claim 1, wherein the wear-resistant component (A) is a ferrous material (Fe>50 wt. %) or, alternatively, a mixture of a ferrous material and a ceramic material (carbide, oxide, nitride, boride, etc.) containing not more than 30 wt. % of a metallic binder, whereby the hardness of the material is greater than HRC 50.

10. The method of claim 2, wherein the wear-resistant component (A) is a ferrous material (Fe>50 wt. %) or, alternatively, a mixture of a ferrous material and a ceramic material (carbide, oxide, nitride, boride, etc.) containing not more than 30 wt. % of a metallic binder, whereby the hardness of the material is greater than HRC 50.

11. The method of claim 2, wherein the tough material component (B) is a ferrous (Fe>50 wt. %) or nickel (Ni>50 wt. %) based material, whereby the hardness of the material is not greater than HRC 35.

12. The method of claim 2, wherein the tough material component (B) is a ferrous (Fe>50 wt. %) or nickel (Ni>50 wt. %) based material, whereby the hardness of the material is not greater than HRC 25.

13. The method of claim 3, wherein the tough material component (B) is a ferrous (Fe>50 wt. %) or nickel (Ni>50 wt. %) based material, whereby the hardness of the material is not greater than HRC 35.

14. The method of claim 3, wherein the tough material component (B) is a ferrous (Fe>50 wt. %) or nickel (Ni>50 wt. %) based material, whereby the hardness of the material is not greater than HRC 25.

15. The method of claim 2, wherein the wear-resistant material component (A) is prepared from a powderized raw material in which the chemical composition of the ferrous metallic powder (Fe>50 wt. %) in the powderized mixture is 0.5-3.5 wt. % carbon, 0.5-15 wt. % chromium, 0-5 wt. % molybdenum, less than 2 wt. % manganese and less than 2 wt. % silicon, and the proportion of the carbide-forming additives such as V, Nb, Ti and W compounds in total is 3-20 wt. % and, additionally, the powderized mixture contains not more than 50 wt. % ceramic particulates in which the proportion of a metallic binder is not greater than 30 wt. %, the rest of the composition comprising impurities or trace amounts of different additives.

16. The method of claim 3, wherein the wear-resistant material component (A) is prepared from a powderized raw material in which the chemical composition of the ferrous metallic powder (Fe>50 wt. %) in the powderized mixture is 0.5-3.5 wt. % carbon, 0.5-15 wt. % chromium, 0-5 wt. % molybdenum, less than 2 wt. % manganese and less than 2 wt. % silicon, and the proportion of the carbide-forming additives such as V, Nb, Ti and W compounds in total is 3-20 wt. % and, additionally, the powderized mixture contains not more than 50 wt. % ceramic particulates in which the proportion of a metallic binder is not greater than 30 wt. %, the rest of the composition comprising impurities or trace amounts of different additives.

17. The method of claim 4, wherein the wear-resistant material component (A) is prepared from a powderized raw material in which the chemical composition of the ferrous metallic powder (Fe>50 wt. %) in the powderized mixture is 0.5-3.5 wt. % carbon, 0.5-15 wt. % chromium, 0-5 wt. % molybdenum, less than 2 wt. % manganese and less than 2 wt. % silicon, and the proportion of the carbide-forming additives such as V, Nb, Ti and W compounds in total is 3-20 wt. % and, additionally, the powderized mixture contains not more than 50 wt. % ceramic particulates in which the proportion of a metallic binder is not greater than 30 wt. %, the rest of the composition comprising impurities or trace amounts of different additives.

18. A multimaterial part manufactured according to claim 2 whose composition includes at least a tough ferrous (Fe>50 wt. %) material component (B) combined with a hard, wear-resistant material (A), wherein:
the tough material component (B) forms in a workable green body an essentially homogeneous longitudinal structure, whose proportion in the green body cross section is 10-50 vol. %,
the cross-sectional area of a single fiber of the tough material (B) is greater than 1 mm² average and the minimum dimension in the cross section of a single fiber or in the wall a honeycomb-like tough structure is greater than 0.5 mm, and
the hardness of the hard material component (A) after heat treatment is not less than HRC 40.

19. A multimaterial part manufactured according to claim 3 whose composition includes at least a tough ferrous (Fe>50 wt. %) material component (B) combined with a hard, wear-resistant material (A), wherein:
the tough material component (B) forms in a workable green body an essentially homogeneous longitudinal structure, whose proportion in the green body cross section is 10-50 vol. %,
the cross-sectional area of a single fiber of the tough material (B) is greater than 1 mm² average and the minimum dimension in the cross section of a single fiber or in the wall a honeycomb-like tough structure is greater than 0.5 mm, and
the hardness of the hard material component (A) after heat treatment is not less than HRC 40.

20. A multimaterial part manufactured according to claim 4 whose composition includes at least a tough ferrous (Fe>50 wt. %) material component (B) combined with a hard, wear-resistant material (A), wherein:
the tough material component (B) forms in a workable green body an essentially homogeneous longitudinal structure, whose proportion in the green body cross section is 10-50 vol. %,
the cross-sectional area of a single fiber of the tough material (B) is greater than 1 mm² average and the minimum dimension in the cross section of a single fiber or in the wall a honeycomb-like tough structure is greater than 0.5 mm, and
the hardness of the hard material component (A) after heat treatment is not less than HRC 40.

21. A multimaterial part manufactured according to claim 5 whose composition includes at least a tough ferrous (Fe>50 wt. %) material component (B) combined with a hard, wear-resistant material (A), wherein:
the tough material component (B) forms in a workable green body an essentially homogeneous longitudinal structure, whose proportion in the green body cross section is 10-50 vol. %,
the cross-sectional area of a single fiber of the tough material (B) is greater than 1 mm² average and the minimum dimension in the cross section of a single fiber or in the wall a honeycomb-like tough structure is greater than 0.5 mm, and
the hardness of the hard material component (A) after heat treatment is not less than HRC 40.
